(19) United States
(12) Patent Application Publication
(10) Pub. No.: US 2005/0034161 A1
(43) Pub. Date: Feb. 10, 2005

(54) Interactive system for enabling tv shopping

(76) Inventor: Andrew Brown, Hampshire (GB)

Correspondence Address: CONNOLLY BOVE LODGE & HUTZ LLP, SUITE 800, 1990 M STREET NW, WASHINGTON, DC, 20036-3425, US

(21) Appl. No.: 10/470,071

(22) PCT Filed: Dec. 10, 2001
(86) PCT No.: PCT/GB01/05448

(30) Foreign Application Priority Data
Jan. 30, 2001 (GB) 0102366.2

(51) Int. Cl. H04N 7/16; H04N 7/173

(52) U.S. Cl. 725/86; 725/1; 725/119

(57) ABSTRACT

An improved interactive system for enabling TV shopping and similar purposes from a central provider by remote customers without the customers having to leave their remote locations. The system has a complex interactive network of co-operating elements, comprising two network distribution means enabling video and audio communications to be established between the customers and the central provider further including video network exchanges, advisors computers and presentation computers at the central provider, extensions to the web-server of the video-enabled network, and gateway processors/computers. The system provides significant performance improvements over known systems, for example in making the advisor's job in giving a presentation easy, offering different connection methods, allowing for multiple advisors/merchants to be connected to a particular customer, allowing multiple networks to be connected to each advisor/merchant and dealing with unexpected closing the calls. The system is not limited in its application to TV home shopping, for example it finds utility for various applications where the management of customer-advisor relationships is involved.

### FIELD OF INVENTION

This invention relates to an improved interactive system for TV shopping and similar purposes, and more particularly but not exclusively, for use as an improved TV shopping system in the home.

### BACKGROUND OF THE INVENTION

Many organisation today operate ‘call centres’ for sales and other purposes. These are real or virtual sales centres to which customer telephone calls are routed. After accessing a manned or automated ‘front office’ function customers are connected to the next available advisor appropriate to their problem. A powerful addition to this trading concept is a call centre which has the additional capacity to present images (‘video’) to the customer via a television or computer display screen. As the skilled man in the art is aware, the ‘visual display unit’ or ‘video display unit’, VDU for short, is applied to both television and computer display screens.

A call centre with a video capability is dubbed a ‘video call centre’ or just ‘video centre’. A video centre must be connected to the customer via a network, which may include both cable and radio-wave signals and has an enhanced capability relative to the telephone network; this might be dubbed a ‘video-enabled network’.

The customer's VDU typically comprises a television set linked to a ‘set-top box’ which converts data from a cable or radio-wave signal into a television video format, or may comprise a computer with a ‘modem’ which converts data from a cable or radio-wave signal into a computer format. Note however that many VDUs incorporate integrally a ‘set-top box’ function and that many computers incorporate integrally a modem function. A remote control keypad unit linked to the set-top box or a computer keyboard allows the customer to communicate commands to the network. A customer typically activates the connection with the video-enabled network by pressing a button on the VDU remote control or operating a mouse or cursor control on an on-screen menu, this action sending a ‘video link request’ command to the video centre.

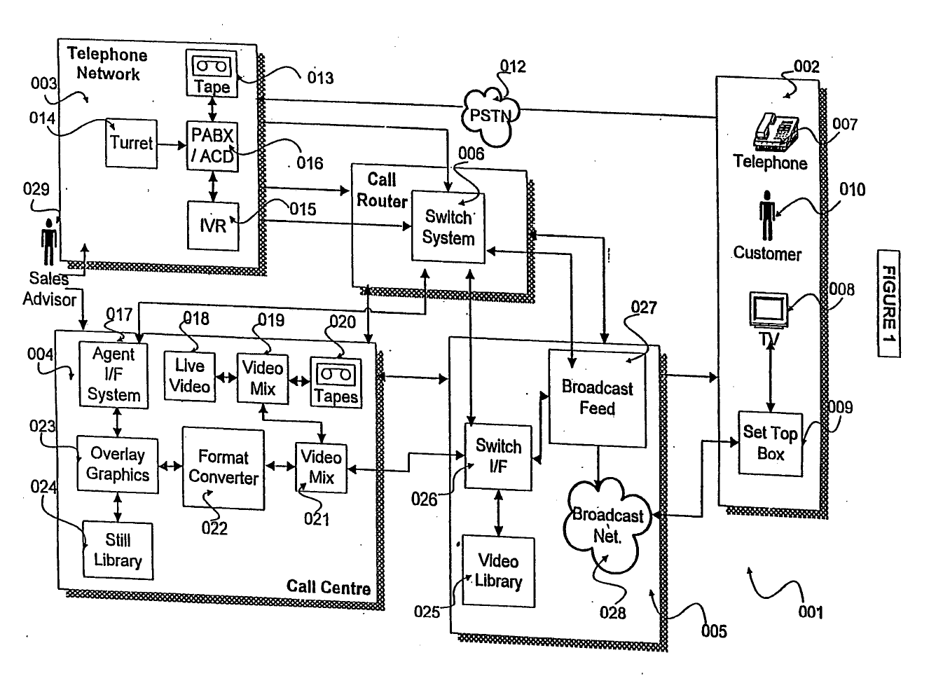

UK Patent Application No. 9817829.6 (Nisaba Group Ltd.), see FIG. 1 for example, describes a video call centre system with co-operating video-enabled and telephone networks which allow a plurality of sales advisors each to communicate with their customer via that customer's telephone and that customer's VDU. In such systems, 2-way audio communication and a one-way video link (a ‘video session’) is established between customer and an advisor at the video centre who can send video and audio data to the customer, including a live video image of their advisor.

Known systems in the relevant field are, however, subject to various drawbacks.

First, in known systems there are sometimes problems in relating a customer's telephone call to that customer's video session. The switching of the advisor onto the customer's video line can be uncertain and transfer of calls between agents can also present difficulties. The identification of the customer's set-top box is not always possible and in some networks it is difficult to reconcile customer's phone numbers and STB numbers.

Second, while known systems make mention of the fact that communications can be initiated by the customer sending a request, for example via the on-screen menu, such systems do not describe different detailed methods for initiating a video session.

Third, in known video centre systems, the advisor is essentially conducting a live multimedia presentation to the customer, which is a difficult process using standard presentation software on a personal computer (PC).

Known systems also do not make sophisticated provision for correct handling of uncontrolled shut-down of a session, due for example to a customer closing the link unexpectedly.

Further, known systems do not provide for phone-back services, where the customer types his/her phone number into the remote control, computer keyboard or telephone keypad and then the merchant calls back on that telephone number.

The present invention aims to overcome or substantially reduce at least some of the above discussed drawbacks.

### OBJECTS AND SUMMARY OF THE INVENTION

It is the principal object of the invention to provide an interactive system for home shopping and similar purposes which is versatile and considerably improved in terms of practical capability over the system of UK Patent Application No. 9817829.6 (Nisaba Group Ltd.) and over other known systems.

In broad terms, the present invention resides in the concept of providing an improved interactive system having a complex interactive network of co-operating elements, including video network exchanges, advisors computers and presentation computers at the video centre, extensions to the web-server of the video-enabled network, and gateway processors/computers. The system of the present invention provides significant performance improvements over known systems when used for home shopping, for example, by making the sales advisor's job in giving a presentation easy, in offering different connection methods, in allowing for multiple merchants to be connected to a customer, in allowing multiple networks to be connected to each merchant and in dealing with unexpected closing of calls.

According to the present invention there is provided an interactive system for enabling TV shopping from a central provider to remote customers, said system comprising:
two network distribution means enabling video and audio communications to be established between the remote customers and the central provider:
(a) one enabling customer telephone communications with the central provider to be routed to particular advisor workstations of the central provider, there being a plurality of such workstations, and
(b) one enabling outgoing audio and video communications from the plurality of advisor workstations to be routed to the respective customers from whom the incoming telephone communications are received;
   means enabling advisors working at said workstations to communicate interactively with the customers and provide images including images of said advisors to the customers to be viewed on the customers' VDUs;
   means enabling the advisors and the customers to effect transactions; and
   means enabling any one of said customers to initiate a video connection further comprising transmitting means for sending a video-link request signal via interactive input system means allowing the VDU's video session data of a particular customer telephone caller to be communicated to the central provider.

The system of the invention conveniently allows a home shopping function to be implemented on an interactive cable TV (CATV) network designed for video on demand (VOD) and other interactive TV services, increasing the network loading and increasing its commercial viability.

Further, in accordance with an exemplary embodiment of the invention, the interactive input system means of the interactive system may be embodied as an on-screen menu system, computer keyboard and/or remote control keypad.

Advantageously, the interactive system may employ a video-enabled network to transmit both audio and video from advisor to customer. The video-enabled network may utilise any of the established standard protocols (IP, ATM, DVB, MPEG, ADSL, etc.) so as to transfer data.

Conveniently, the sales advisor in a video centre is equipped with a personal computer (PC) (advisor PC or APC) which is connected by a network to another PC (presentation PC or PPC) which produces a multimedia presentation to the customer, the video centre being connected to a gateway processor/computer which communicates with a web-server which serves the set-top boxes of a video-enabled network. In this connection, the gateway processor/computer component serves to communicate data between the advisors/merchants and the customers including for example the kind of data indicative of which on-screen menu icon/input key is to be operated by the customer, and which set-up box number (STB#) from customer to particular merchant/advisor video call centre is to be communicated with. Therefore, by virtue of such means for communicating with the STB to obtain STB# and merchant/advisor identity, it is possible to correctly route call through to head end and to the particular merchant/advisor video call centre.

In one embodiment, the correct connection of the advisor to the customer's telephone and the advisor to the correct presentation PC is achieved by means of the customer reading aloud or otherwise relaying an on-screen video or audible identifier generated by the PPC to the advisor or a front office advisor or a front office IVR system.

In another embodiment, the correct telephone connection of the advisor to the customer's telephone and the advisor to the correct presentation PC is set up automatically, the PPC sending an image including a telephone number and identifier which the customer can dial on his or her telephone, the telephone number connecting the customer to the video centre and the identifier forwarding the customer's call to an advisor who can be connected to the correct PPC.

Conveniently, the correct telephone connection of the advisor to the customer's telephone is achieved by the customer dialling a telephone number with extra digits which operates a direct dial in (DDI) function in the video centre branch telephone exchange (PABX). Note also that images sent to customers may advantageously include live video images of advisors.

Preferably, the audio and video communications from the plurality of advisor workstations are enabled to be routed to the customers' VDUs by means of set-top boxes or equivalent which are addressable. Also, the audio and video communications from the plurality of advisor workstations may be conveniently enabled to be routed to the customers' VDUs by means of set-top boxes or equivalent which are adapted only to unencrypt transmissions which are encrypted and intended for viewing only on those particular set-top boxes.

Note, however that while it is preferred to use separate APCs and PPCs in the system of the invention it is possible to instead use just a single APC for each advisor, each APC having a built-in PPC function.

According to another embodiment, the advisor is able to control the presentation to the customer with his own APC, with the presentation actually being outputted in final form by the PPC, this expediting the potentially difficult process of offering a live multimedia presentation (including a live advisor image) to the customer because additional control and cursor features may appear on the advisor's display screen which do not appear as distractions on the customer's screen.

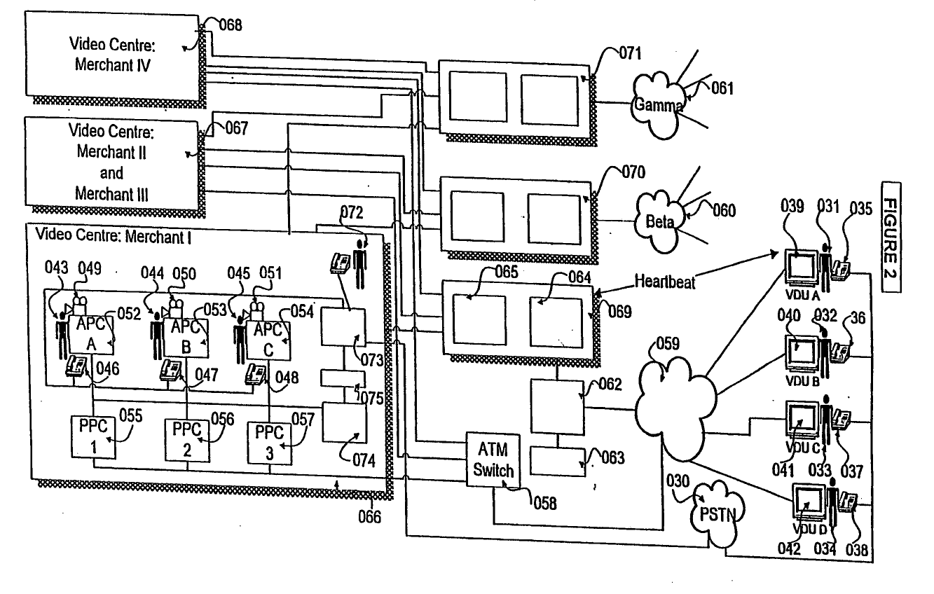

In another embodiment a number of APCs and PPCs are advantageously connected together via two parallel local networks, one for advisor live video/audio and one for control data, at the video centre in the system of the invention (as shown for example in FIG. 2 hereinafter), allowing arbitrary connection of advisors to customers, and allowing simple transfer of video calls between advisors.

In another embodiment, there is control software on the APC and software on the PPC which together allow the manipulation of data by advisors and the processing of data for transmission to the customer, and more particularly, allows the advisor to ‘drag and drop’ images including live images and audio and present graphical and alphanumeric data to the customer's VDU ergonomically.

In another embodiment of the invention the web-server of the CATV network communicates with a gateway processor/computer which controls a routing of video communications from the video centres to the head end of the CATV network via the ATM switch, and sends session data like the STB number to the correct merchant's video centre.

In another embodiment, a video centre network exchange is attached to each network gateway computer allowing the connection of multiple networks to multiple merchants, networks with different transmission standards (IP, AIM, MPEG, ADSL etc.) being capable of being connected to a particular video centre.

In another embodiment, data coming from the video centre network exchange as described hereinafter is handled by a video centre exchange and passed on to the local network of APCs and PPCs, this video centre exchange also optionally communicating with a PABX in the video centre.

In another embodiment, a ‘heartbeat’ of regular communications is advantageously maintained between gateway processing means (computer) and the customers VDU set-top box, allowing the rapid automatic detection of any unexpected session closure, such as a network failure or sudden customer log-off.

In another embodiment, the customer's set-top box or equivalent communicates with a web-server on the CATV network which can give initial information, such as a merchant's web-page, before connection of the customer to a merchant's video centre, this immediate communication reassuring the customer of correct connection, and allowing initial information to be communicated to the customer.

In another embodiment, after the live video session with a sales advisor has ended, a video advertisement may be offered, or alternatively a questionnaire session may be provided to the customer.

Advantageously, the system of the invention may include a phone-back facility in which the customer may leave a telephone number, using his telephone keypad to transmit the data, and enabling an advisor or other person at the video centre to call him back on. Also, the system of the invention may conveniently include equipment providing automation of some or all elements of the front office function using the customer's telephone keypad and audio feed back of instructions to the customer, such equipment being a version of interactive voice response (IVR) equipment.

In another embodiment, routing of phone calls for people with a video connection is arranged down a different trunk to those ringing the standard call centre telephone number (e.g. a national contact number); this conveniently avoids leaving customers with a video connection not being able to secure an audio link to the advisor due to traffic congestion on the telephone network.

Further it is to be appreciated that multiple set-top boxes (or equivalent) may be enabled to receive the video from the advisor's PPC, and multiple advisors' APCs may be patched into 1 PPC and a ‘conference call’ mode may be initiated with the telephone system, allowing situations like video auctions and video education to be accommodated.

The system of the invention therefore provides a considerably improved interactive process for TV shopping by way of interactive communication between remote customers and advisor workstations (staffed by advisors) of the central provider. The system can be implemented at reasonable cost and finds utility for various applications where the management of customer-advisor/merchant relationships is involved.

### BRIEF DESCRIPTION OF THE DIAGRAMS

FIG. 1 is a schematic block diagram illustrating the known system of British Patent Application No. 9817829.6 (Nisaba Group Ltd.);

FIG. 2 is a schematic block diagram of the interactive system embodying the present invention illustrating the components of the interactive system in detail;

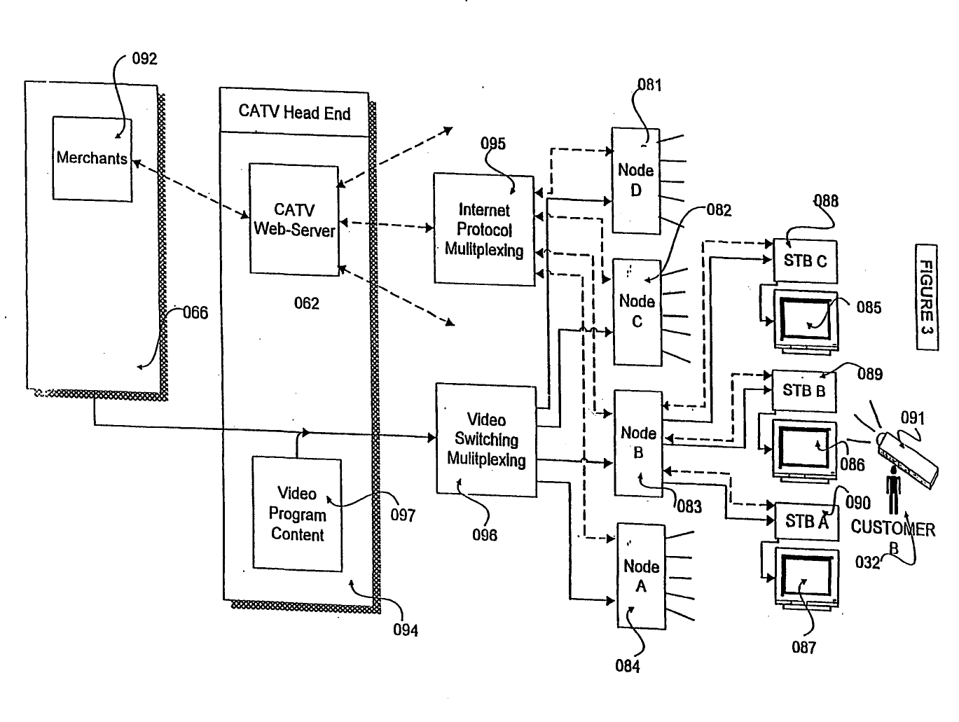

FIG. 3 is another schematic block diagram of the interactive system of the invention illustrating how the on-screen menu web-server connects into the CATV network; and

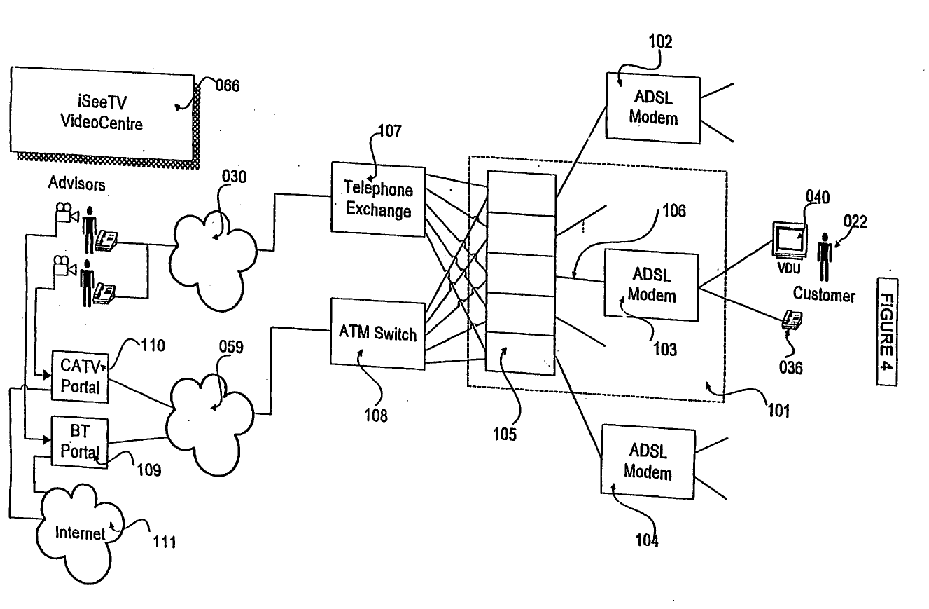

FIG. 4 is another schematic block diagram of the interactive system embodying the present invention illustrating how the system is adapted to function using ADSL and similar networks.

### DETAILED DESCRIPTION OF EMBODIMENTS OF THE INVENTION

### 1. Known Systems

FIG. 1 is a schematic block diagram of an embodiment of a known interactive system 1 for TV shopping as disclosed in British Patent Application No. 9817829.6 (Nisaba Group Ltd). As shown a customer subsystem 2 is connected via telephone network 12 and CATV network 5 to video call centre 4 which is connected to telephone subsystem 3 and control/switching system 6.

In operation of the system 1, a customer 10 using VDU 8 (which has a set-top box (STB) 9) and telephone 7 communicates with sales advisor 29 with telephone instrument 14, the telephone call having been routed by PABX/automatic call distribution systems (ACD) 16. Live video images of the advisor are provided by image-capturing means 18 and are combined using video mixing 19 and 21 with graphics from the video graphics generator 23 and video format converter 22, video libraries 20 and 24, and sent to the CATV network head end, where there is a further video library 25 and switching unit 26. At the CATV head end the interactive TV shopping video feed from 26 is scrambled so that only an STB with the correct descrambling algorithm may unscramble it. The broadcast feed 27 is then added to the scrambled interactive TV shopping video feed and sent to each ‘serving area’ within the CATV network 28. Each STB 9 is in one serving area, which typically may contain up to several thousand STBs. STB 9 is adapted to unscramble only interactive TV home shopping video intended for that STB.

### 2. Interactive System of the Invention

FIG. 2 shows schematically the various components of the interactive system of the invention. Remote customers 31, 32, 33 and 34, as shown, communicate via telephone instruments 35, 36, 37 and 38 and via VDUs 39, 40, 41 and 42 with sales advisors 43, 44 and 45. The sales advisors use telephone instruments 46, 47 and 48 to talk, and send images of themselves using cameras 49, 50 and 51 to the customers. Advisors personal computers (APCs) 52, 53 and 54 are linked via switching networks to presentation personal computers (PPCs) 55, 56 and 57, which provide feed via the ATM switch 58 to the video-enabled network 59 which in turn feeds the respective VDUs. The telephone network 30 connects the customers' telephones 35 to 38 with the video centre PABX 73.

The video-enabled network 59 has a web-server 62 which is designed to provide interactive data exchange between the on-screen menu systems or equivalent of the VDUs and the merchant web-pages 63. The web-server is also designed to communicate with a gateway computer 64 which routes data such as set-top box number and service request data via a video centre network exchange 65 to the video centres 66, 67 or 68. A video centre advantageously includes more than one merchant, so that video centre 67 (as shown) includes both Merchant II and Merchant III services.

Any of the video-enabled networks 59, 60 or 61 is adapted and arranged to be connected via their gateway and video centre network exchange subsystems 69, 70 and 71 to any of the video centres 66, 67 or 68.

Each video centre includes one or more front office persons 72 who are equipped with telephone instruments, a PABX 73 and a video centre exchange 74. The PABX is designed to interface with the video centre exchange via a computerised telephone interface (CTI) 75.

Broadband, Broadcast and Video-Enabled Networks

The telephone network is ubiquitous in most parts of the world, and would be a convenient network for the present invention because it is basically designed to provide one-to-one communication. However, the telephone network is conventionally incapable of providing sufficient data bandwidth to allow the use of quality video images at a speed sufficient for sales transactions and similar activities to take place, as required for the invention. However, the system of the invention is workable using the ADSL concept, described hereinafter, which although it uses telephone wires in the last local link to the customer is capable of a much higher bandwidth.

The interactive system of the invention is designed to work with any broadband network which carries carry data at a sufficient rate for adequate image transmission quality and speed, what might be called a ‘video-enabled’ network. But the most ubiquitous video-enabled networks are basically designed to provide one-to-many (‘broadcast’) functionality. However, many of these networks have some, albeit limited, one-to-one communication capability. It is this limited capability that the system of this invention exploits.

Use of Broadcast Networks for One-to-One Communications

Referring to FIG. 3, in a video-enabled network system such as a CATV system (similar considerations apply to non-cable broadcast networks like DVB-T) video feed is provided to all customers in a zone or ‘serving area’ via nodes 81 to 84. It is possible to send video to a particular one of the customers' VDUs 85, 86, 87 by a one or a combination of switching video onto channels in the customer's serving area, remotely enabling access to the video feed for that customer's VDU by means of a control/address function, and scrambling the transmission so that only that customer's VDU may unscramble the data. The ‘set-top box’ (STB) is the name given to the elements 88, 89, 90 of the network which is normally located at the customer's site. The STB has some control/address switching functions and some unscrambling functions. The STB also includes functions allowing customer input, which is typically via a remote control keypad unit 91 which transmits instructions to the STB.

With these capabilities available, it is possible to apply the system of the invention to advantage. More particularly, as shown, merchants 92 operate in a video centre 66 in which there are multiple sales advisors in video communication with customers. Each sales advisor is equipped with computer workstations and may help a customer to buy products and services by means of audio received from the customer and video and audio, including live images of the advisor, transmitted via the CATV head end 94 along with other video content 97, and via the video switching system 96 and nodes 81 to 84, to the customer end of the CATV network. The network typically employs a quadrature amplitude modulation (QAM) radio frequency (RF) signal format at the customer end. The head end also includes a web-server 62 which communicates via an Internet Protocol (IP) switch 95 with the nodes 81 to 84 and thence with the customers 32 using IP format video and audio and control data.

APCs & PPCs

Referring to the system of the invention illustrated in FIG. 2, presentation PCs (PPCs) are connected via the ATM switch to the head-end of the video-enabled network and thence to the customers.

It is possible for one APC to be connected to one PPC. However, the system of the invention has enhanced capabilities if the APCs and PPCs are connected via an interchange switch system.

In the preferred embodiment of the invention, the advisor PCs (APCs) are connected to the PPCs via a local area network for control data, and via a switch network (video ‘matrix’ switch) for live video and audio from the agent. The particular advantages of the use of separate PCs for advisor use and for presentation generation are firstly that an advisor may connect his APC to any PPC via the local network and matrix switch, once informed about which PPC a customer is connected to; and secondly that an advisor's PC may display not only the presentation as relayed to the customer, but also various control and cursor features which expedite the otherwise difficult process of producing a multimedia presentation to the customer ‘on the fly’. These additional control and cursor features do not appear as distractions on the customer's screen display produced by the PPC.

The local network of PPCs and APCs is connected to the network gateway via a video centre exchange. Data items coming from the video centre network exchange like requests for service and set-top box number are handled by a video centre exchange and passed on to the local network of APCs and PPCs, this video centre exchange also optionally communicating with a PABX in the video centre.

The APCs control a ‘farm’ of PPCs and there may be more or fewer APCs than there are PPCs. It is also possible to devise a working system using only APCs, provided the APCs are equipped with suitable additional software and hardware to perform the PPC duties. The preferred alternative is to separate the functions, putting them on separate APCs and PPCs.

APC/PPC Software

The software running on the APC and PPC advantageously includes software known as a ‘rendering engine’. It is capable of a number of functions within its role of creating a live ‘on-the-fly’ multimedia presentation to the customer, namely:
can put up live video, stored videos (MPEG, bit-maps, HTML, shockwave, audio and other multimedia data types)
offers arbitrary or preplanned play patterns, for example repeat, replay, ordered and branching play patterns
uses frameless windows
offers an ergonomic mouse-controlled GUI on the APC display which is invisible on the PPC output display
can transfer a PPC session seamlessly to another APC
may optionally include a ‘feedback screen’ in a window on the APC display showing the advisor exactly what the customer is seeing.
   Normal Mode of Operation

The customer's set-top box or equivalent has an identifier which allows the video-enabled network operator to connect a video link (a ‘video session’) from a PPC at a video centre to that customer via the ATM switch and the video-enabled network. The video session thus established will have a unique identifier code which is used for the management of the system of the invention. However, in general the system of the invention will not know to which video session or to which PPC a particular customer telephone call relates. The advisor does not need to know the session or set-top box identifier, or any other details of the video-enabled network connection: however, the advisor does need to know from which PPC at the video centre the customer has a video session.

The operation of the system of the invention is normally as follows: after sending a video link request, the customers are sent an initial VDU display, the ‘banner screen’, on which they are asked to call the video centre phone number. When they telephone the video centre a front office person replies. The banner screen also displays an identifier code. The code indicates to which PPC their video feed is connected. The customer tells the front office person this code. The front office may then connect their telephone call to an advisor whose APC is connected to the PPC which is providing that customer's video feed.

The ‘banner screen’ may include audio including an audible version of the identifier.

The use of a front office allows the optimisation of the valuable time of advisors while giving customers the fastest possible service. Customers with straightforward needs are simply given the next available advisor, while customers who have special requirements or wish to talk to a particular advisor can be queued for the appropriate advisor.

IVR

The front office function may be advantageously replaced partly or entirely by an automated system, such as those systems which are operated by the telephone keypad and which feed back audio instructions and information to the customer, these systems being often known as interactive voice response systems or IVRs. Alternatively more sophisticated automated front office functions may be provided by more complex systems including ‘voice recognition’, where the customer's verbal instructions are decoded into computer data format.

Other functions of the front office such as the appropriate and efficient distribution of customer calls to sales advisors can also be automated: this function is often described as an automated call distribution or ACD function.

Session Connection Communicated Via Telephone Keypad

An alternative automated connection method is where the customer is given a video session identifier which they can type into their telephone dialling keypad. The identifier can then be used in the video centre to route the telephone call to an advisor who may connect their APC, perhaps automatically, to the PPC which is providing the customer's video feed. This can be achieved most easily if the video centre exchange co-operates with the video centre PABX via a computerised telephony interface (CTI) interface. If each APC is connected to only one PPC, then a standard PABX with direct dial interface (DDI) will suffice. According to the preferred embodiment of the system in which any given APC may be connected to any PPC, a look-up table is required to temporarily store the information about which PPC has which APC connected to it. A PABX with a sophisticated DDI function extended to include a look-up table function for relating customer PPC assigments to advisor PPC assignments can be used for this purpose.

Telephone Call First Mode of Operation

In an alternative connection protocol, a video centre front office person makes a telephone call to the customer initially. The call centre person asks the customer to send a video link request for the appropriate merchant service. The banner screen display on the customer's VDU screen when video connection is achieved includes an identifier which indicates to which PPC the customer's video feed is connected. The customer tells the front office person this code. The front office then connects their telephone call to an advisor whose APC is connected to the PPC which is providing the customer's video feed. As discussed hereinabove, some elements of this protocol can be carried out by an automated system.

In another alternative connection protocol an advisor is already in telephone communication with the customer but no video connection exists. The advisor asks the customer to send a video link request for the appropriate merchant service. The display on the customer's TV screen when video connection is achieved includes an identifier which indicates to which PPC the customer's video feed is connected. The customer tells the advisor this code. The advisor may then connect his or her APC to the PPC which is providing the customer's video feed.

Direct Dial in to a Particular Advisor

The system of the invention can be operated to provide a simple direct line number on the banner screen for the customer to dial in on. The banner screen simply displays the direct dial number of the advisor whose PPC is connected to the video feed. The customer simply dials this number and speaks to the advisor.

Video Centre Network Exchange

A video centre network exchange is preferably used for routing communications between the merchants' video centres and the gateway computer. The video centre network exchange allows the connection of multiple merchant video centres to a video-enabled network. Each network gateway may be equipped with a video centre network exchange, so that in total the system of the invention allows the connection of multiple merchants at multiple video centres to multiple video-enabled networks. In addition more than one merchant may use a single video centre.

The video centre network exchange is preferably split in practice into units located at the network head end(s) and units located at the video centre end(s). With a video centre network exchange in the system, the customer may request service from different video centres provided by different merchants. Similarly, merchants may use a single video centre to provide service to customers on different video-enabled networks.

Video Network On-Screen Menu Web-Server

Many video-enabled networks such as CATV also include a web server which can interchange information with a customer's set-top box or equivalent under the command of the customer's remote control keypad or computer keyboard. The system of the invention extends such a web-server by providing it with software and hardware for accessing the gateway computer of the system and also for accessing data from a merchant independently of connection to the merchant's video centre. The web-server extension may put up an interactive web-page display before connection of the customer to a merchant's video centre, this immediate communication reassuring the customer of correct connection, and perhaps also allowing some customers to satisfy their needs without the necessity of contacting the video centre.

Post Live Session Videos and Questionnaires

A customer who has just finished the live interactive session will be motivated to watch a promotional video and/or provide data useful for marketing purposes without involvement of advisor time. The web-server may be used to do this by offering a web-page from the merchant which includes for example a video advertisement or a questionnaire.

Gateway Computer

The gateway computer of the invention commands the ATM switch to connect the particular virtual circuit from a merchant's video centre to the head end of the video-enabled system, provides the correct STB code to ensure that the correct customer receives the video feed, and alerts the correct merchant's video centre that a video session is about to start.

A gateway computer and video centre network exchange may be required for each network.

Heartbeat Function Gateway<->STB

The gateway computer also preferably provides a ‘heartbeat’ function. The gateway computer and the STB exchange signals on a regular basis every few seconds while the video session is valid. In the event of the customer disconnecting at his end, or in the event of a system failure, the heartbeat process fails and the gateway computer is programmed to close down the session promptly and tear down the connections established.

ADSL

The system of the invention is envisaged to be used with data transmission methods such as ADSL (asymmetric digital subscriber line) in which high speed data including video image data may be transmitted alongside audio to the customer. Using ADSL, the two co-operating networks of the invention have the last piece of the communication pathway (from street box or local exchange to the customer premises) in common, rather than being separate right up to the customer's premises, but the functioning of the invention is the same.

FIG. 4 illustrates the operation of the system of the invention with ADSL. Left of the local telephone exchange 107 marked on the diagram the system is as described above and in FIG. 2. However, the telephone network 30 and video-enabled network 59 do not proceed directly to the customer 22 separately but are combined together into the local ADSL link 101. The customer is linked to the telephone exchange by a conventional telephone line which is equipped with special electronics—the ADSL modem 102, the digital subscriber line (DSL) access multiplexer 105 and the telephone line 106 altogether constituting the ADSL link. A single DSL unit 105 communicates with a multiplicity of modems 102, 103 and 104. The link allows high bandwidth (typically from 0.5 to 8 Mbits/second) data transmission, including both image and audio data from the telephone exchange to the customer and lower bandwidth data, including audio data, from customer to exchange. The bandwidth from exchange to customer is sufficient for high quality moving and live video images on the VDU 40. The ADSL link multiplexes video and audio data, the audio data being split off by the modem 103 to the telephone instrument 36. The DSL unit splits communications with customers into a two-way audio link via the telephone exchange 107 and a one-way (video-enabled network to customer) link to customers via an ATM switch 108. The video-enabled network 59 communicates with multiple portals 109 and 110, which provide access to one or more video centres 66 as well as services such as the Internet 111.

Phone-Back Facility

During busy times, or at night when the video centre may not be staffed, phone-back functions are useful. These are automated services where the customer types his/her phone number into the telephone keypad, and special software in the video centre PABX/ACD (automatic call distribution) system stores the customer's number and an advisor as soon as one is available is requested by the ACD or equivalent to call that customer.

Alternatively, the phone-back function is provided by means of the STB remote control, computer keyboard or equivalent. When the service is busy a ‘sorry we are busy’ message appears and invites the customer to enter his phone number for the automated system to store and cause an advisor of the merchant to call back the customer on that telephone number at a later time.

Having thus described the invention by reference to specific embodiments, it is to be well understood that the embodiments in question are exemplary only and that modifications and variations as will occur to those possessed of the appropriate knowledge and skills may be made without departure from the spirit and scope of the invention as set forth in the appended claims and equivalents thereof. For example, it is to be appreciated that systems which use different specific components in parts of the interactive network would not depart from the concept of this invention, so that the ATM (Asynchronous Transfer Mode) switch of the invention could be replaced by another, e.g. an Internet Protocol (IP) broadband switch, while the CATV network could be replaced by another video-enabled network. Similarly the term PC (personal computer) could be taken to refer not only to computers conforming to the IBM PC specification, but also to computers of other specifications with similar capabilities.

Further, the interactive network of the system of the invention could include POTS, mobile phone network, IP, ADSL, DVB, DVB-T, satellite and ISDN networks for transmitting the video to the customer. Within these, ADSL and mobile phone networks would be considered to be particularly important.

### Glossary

3G—3rd generation, refers to mobile comms. of the future (after WAP), possibily capable of ISeeTV function

AA—automated attendant—more sophisticated than an IVR, in that there may be a voice recognition system.

APC—advisor personal computer

ADSL—asymmetric digital subscriber line: network standard with high bandwidth link to customer and low bandwidth link from customer using the ‘local loop’ telephone lines (from the local telephone exchange to the customer).

ATM—asynchronous transfer mode: standard for transmission of blocks of digital data over ultra-high speed links, eg. from video centre to head end.

CATV—cable TV: the CATV network has a bandwidth measured in 100's of MHz, and can carry hundreds of simultaneous live video channels.

DDI—direct dial in: adding extra digits to a telephone number to directly access extensions on a PABX

DVB-T: digital video broadcast-terrestrial—radiated carrier wave digital TV via a standard antenna (as opposed to digital satellite TV using a radiated wave or cable TV which does not use a radiated wave). It is limited in its use in an ISeeTV system because it has too many TV sets on one repeater (10-100,000) and too few channels even with data compression.

EPG—electronic programme guide: a system on the TV screen for displaying TV programme time and content controlled by the television remote control. The EPG is generally a one-way link, providing data from the CATV company to customers, but in PPV applications there is 2-way data communication.

An on-screen menu (below) is the logical development of this

GUI—graphical user interface: means of controlling a computer via a display and cursor (mouse) movements and clicks

Head End—technical ‘studio’—place where CATV content is put into the CATV network to customers

HTML—hypertext mark-up language, the language used by web-pages

IP—Internet protocol—the data structure used for WWW communication, may include data, video and audio. An ordinary telephone line has insufficient bandwidth using IP protocol to offer sufficient quality moving live images for ISeeTV operation, although there are companies who are using still images for home shopping over IP.

ADSL technology makes it possible to send live images over a telephone local loop link using IP protocol.

ISDN—integrated services digital network: the high speed telephone line-based data service (branded B T Highway) which extends the capability of telephone lines for video and IP data (including video) versus POTS. It is capable of offering ISeeTV type services, for example in business-to-business environment or intra-business helplines.

IVR—interactive voice response system in which audio instructions allow a computer to communicate with a customer who feeds back information via the keys of the telephone

JPEG—Joint Photographic Expert Group: compressed still image data.

MPEG—Motion Pictures Expert Group: standards for compressing data and data structures for transmission, can send images, audio and data simultaneously

NVOD—near video-on-demand: in which customers request a video of a movie from their CATV company, but it is not delivered instantly, but they have to wait, often achieved by providing controlled access to continuous overlapping broadcast transmissions of a small number of content features, eg. major recent Hollywood movies.

On-screen menu—a more sophisticated EPG, capable of accessing and displaying a much wider range of data, typically from a web-server connected to the CATV network

PABX—branch exchange (site telephone exchange)

PPV—pay-per view: see VOD

POTS—Plain Old Telephone System, also known as PSTN

PPC—presentation personal computer

PSTN—public switched telephone network, see POTS, with a bandwidth of only a few kilohertz, it cannot currently provide live video, although improvements in compression software may make poor quality images available.

Shockwave—vector graphics data format, providing an effectively highly compressed format for allowing animations with minimal bandwidth

STB—Set-top box: the device which provides unscrambling software and channel selection, and possibly EPG and CATV web-server access.

VOD—video on demand: where by telephoning or by remote control keypad access customers can access video streams which are provided uniquely to them, usually a pay-TV system. Requires addressable STBs and large bandwidth.

WAP—wireless application protocol: the means of putting data onto current generation mobile phones—not quite good enough for ISeeTV currently.

UMTS—one of the 3G standards, see 3G.

1. An interactive system for enabling TV shopping from a central provider to remote customers, said system comprising:
two network distribution means enabling video and audio communications to be established between the remote customers and the central provider:
(a) one enabling customer telephone communications with the central provider to be routed to particular advisor workstations of the central provider, there being a plurality of such workstations, and
(b) one enabling outgoing audio and video communications from the plurality of advisor workstations to be routed to the respective customers from whom the incoming telephone communications are received;
means enabling advisors working at said workstations to communicate interactively with the customers and provide images including images of said advisors to the customers to be viewed on the customers' VDUs;
means enabling the advisors and the customers to effect transactions; and
means enabling any one of said customers to initiate a video connection further comprising transmitting means for sending a video-link request signal via interactive input system means allowing the VDU's video session data of a particular customer telephone caller to be communicated to the central provider.

2. An interactive system as claimed in claim 1, wherein said interactive input system means comprises an on-screen menu system.

3. An interactive system as claimed in claim 1, wherein said interactive input system means comprises a computer keyboard.

4. An interactive system as claimed in claim 1, wherein said interactive input system means comprises control keypad means, a remote control keypad for example.

5. An interactive system as claimed in claim 1, further comprising video-enabled network means for enabling said outgoing audio and video communications to be routed to said remote customers.

6. An interactive system as claimed in claim 1, wherein said video session data are communicated to the central provider by means of any one of said customers providing a predetermined code to one of the advisors at the central provider.

7. An interactive system as claimed in claim 6, wherein said code is generated by the particular customer's VDU screen and/or relayed to customers as an audio signal.

8. An interactive system as claimed in claim 7, wherein the communications associated with said code comprise audio communications between said particular customer and said one of the advisors.

9. An interactive system as claimed in claim 7, wherein said video session data are communicated to the central provider by means of the particular customer telephone caller providing a predetermined code into the telephone input means, the telephone keypad for example.

10. An interactive system as claimed in claim 9, wherein said code is provided for transmission to automated system means at the central provider.

11. An interactive system as claimed in claim 9, wherein said images comprise live video images of the advisors at the central provider.

12. An interactive system as claimed in claim 9, wherein said customers' VDUs are provided with decoder means at the respective remote customers' locations.

13. An interactive system as claimed in claim 12, wherein said decoder means is an addressable set-top box.

14. An interactive system as claimed in claim 12, wherein said decoder means is arranged to selectively unencrypt encrypted data transmissions which are intended for viewing only on said customers' VDUs.

15. An interactive system as claimed in claim 12, further comprising computer network means at the central provider having video/audio data presentation means and data compression and/or encryption means associated therewith.

16. An interactive system as claimed in claim 15, wherein said computer network means comprises an interactive network of a multiplicity of computers, personal computers (PCs) for example, at the central provider including (a) controllable computer means for the advisors, advisor personal computers (APCs) for example, (b) presentation computer means, presentation PCs for example, providing video/audio data presentation on a local network and (c) compression means enabling the data to be compressed for transmission to the remote customers.

17. An interactive system as claimed in claim 16, wherein the presentation PCs are operable in dependence upon the operation of the advisor personal computers (APCs).

18. An interactive system as claimed in claim 16, wherein any one of said presentation PCs is controllable by any one of said advisor personal computers (APCs).

19. An interactive system as claimed in claim 16, wherein the advisor personal computers (APCs) are adapted and arranged to provide live video and audio feed connection from said particular advisor workstations to said presentation PCs in the network.

20. An interactive system as claimed in claim 19, wherein said connection is established via video/audio switch network means, thereby enabling a transfer of video sessions between the advisors.

21. An interactive system as claimed in claim 16, wherein the advisor PCs and/or presentation PCs are provided with control software means enabling the manipulation by advisors and the processing of data for transmission to the remote customers.

22. An interactive system as claimed in claim 16, further comprising feedback screen means provided at a window on a particular advisor personal computer (APC), enabling image representations presented to a customer to be presented to a particular advisor.

23. An interactive system as claimed in claim 16, further comprising gateway processing means for communicating data between the local network at the central provider and the customers.

24. An interactive system as claimed in claim 23, wherein the data communicated between the advisors and the customers are indicative of the operational status of said network distribution means including the operational status of said interactive input system means when in use.

25. An interactive system as claimed in claim 23, wherein said gateway processing means are arranged to be connected to video network exchange means permitting one or more video networks to be connected to one or more of the advisors workstations of the central provider.

26. An interactive system as claimed in claim 25, wherein said advisor workstations are positioned at various locations in one or more call center subsystems of said central provider.

27. An interactive system as claimed in claim 23, further comprising communication means for providing a facility for maintaining a heartbeat of communications between said gateway processing means and the customer's VDUs enabling connection failures in the system to be detected.

28. An interactive system as claimed in claim 23, further comprising two-way communication means with associated server computer means enabling data to be provided to the remote customers.

29. An interactive system as claimed in claim 28, wherein the two-way communication facility is provided by the interactive input system means, for example by provision of VDU on-screen menu system means.

30. An interactive system as claimed in claim 28, wherein the data are provided to the customers in a web-page format.

31. An interactive system as claimed in claim 28, further comprising transfer means permitting interactive interrogation of any one of said customers by said server computer means upon completion of an interactive communication session between the particular customer and one of the advisors.

32. An interactive system as claimed in claim 28, further comprising means enabling any one of the customers to view particular video representations on a customer's VDU, via video-enabled network means, for example upon completion of an interactive communication session between the particular customer and one of said advisors.

33. An interactive system as claimed in claim 28, further comprising means for providing a phone-back facility whereupon any one of the customers is able to provide telephone number-related information to the central provider and any one of said advisors is subsequently enabled to phone back the particular customer.

34. An interactive system as claimed in claim 28, further comprising automated means for providing interactive communications between the advisors and the customers.

35. An interactive system as claimed in claim 34, wherein said automated means is operable in dependence upon the input of information by any one of said customers enabling information input by a particular customer, into the telephone key pad for example, to be conveyed back to said particular customer in audio-form.

36. (Cancelled)
